(19) United States
(12) Patent Application Publication
(10) Pub. No.: US 2021/0012195 A1
(43) Pub. Date: Jan. 14, 2021

(54) INFORMATION PROCESSING APPARATUS

(71) Applicant: KYOCERA Document Solutions Inc., Osaka (JP)

(72) Inventor: Masafumi Tsutsumi, Osaka (JP)

(73) Assignee: KYOCERA Document Solutions Inc.

(21) Appl. No.: 16/924,077

(22) Filed: Jul. 8, 2020

(30) Foreign Application Priority Data
Jul. 12, 2019 (JP) 2019-130732

(51) Int. Cl. G06N 3/08; G06F 16/28

(52) U.S. Cl. CPC G06N 3/08; G06F 16/288

(57) ABSTRACT

In an information processing apparatus, a learning control unit causes a machine learning processing unit to perform machine learning of a predetermined neural network in accordance with hyperparameters. Further, the learning control unit performs former-stage learning and latter-stage learning after the former-stage learning, and (a) in the former-stage learning, causes the machine learning processing unit to perform the machine learning with a single value set of the hyperparameters until a predetermined first condition is satisfied and saves a parameter value of the neural network when the predetermined first condition is satisfied, and (b) in the latter-stage learning, sets an initial parameter value of the neural network as the saved parameter value of the neural network and changes a value set of the hyperparameters and causes the machine learning processing unit to perform the machine learning with the value set until a predetermined second condition is satisfied.

### CROSS-REFERENCE TO RELATED APPLICATIONS

This application relates to and claims priority rights from Japanese Patent Application No. 2019-130732, filed on Jul. 12, 2019, the entire disclosures of which are hereby incorporated by reference herein.

### BACKGROUND

### 1. Field of the Present Disclosure

The present disclosure relates to an information processing apparatus.

### 2. Description of the Related Art

A learning system estimates an estimation function that expresses a relationship between a learning result obtained through machine learning and hyperparameters of the machine learning, and shortens an adjustment process of the hyperparameters by limiting ranges of the hyperparameters on the basis of the estimation function.

However, in the aforementioned system, it takes relatively long time for estimating the estimation function, and time required for machine learning and evaluation of a learning result is not shortened on each set of values of the hyperparameters even in the limited ranges of the hyperparameters.

### SUMMARY

An information processing apparatus according to an aspect of the present disclosure includes a machine learning processing unit and a learning control unit. The machine learning processing unit is configured to perform machine learning of a predetermined neural network. The learning control unit is configured to cause the machine learning processing unit to perform machine learning in accordance with hyperparameters. Further, the learning control unit performs former-stage learning and latter-stage learning after the former-stage learning, and (a) in the former-stage learning, causes the machine learning processing unit to perform the machine learning with a single value set of the hyperparameters until a predetermined first condition is satisfied and saves a parameter value of the neural network when the predetermined first condition is satisfied, and (b) in the latter-stage learning, sets an initial parameter value of the neural network as the saved parameter value of the neural network and changes a value set of the hyperparameters and causes the machine learning processing unit to perform the machine learning with the value set until a predetermined second condition is satisfied.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an information processing apparatus according to an embodiment of the present disclosure; and

FIG. 2 shows a flowchart that explains a behavior of the information processing apparatus shown in FIG. 1.

### DETAILED DESCRIPTION

Hereinafter, embodiments according to an aspect of the present disclosure will be explained with reference to drawings.

### Embodiment 1

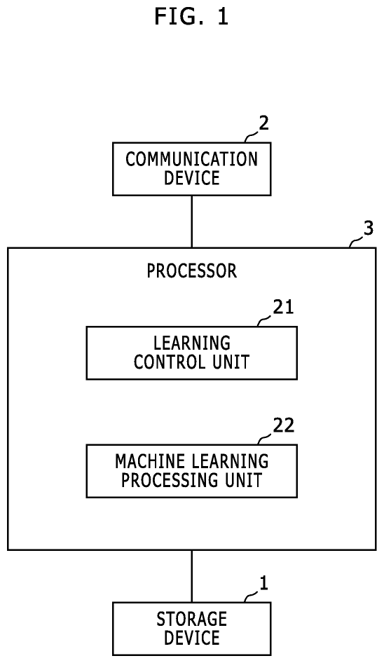

FIG. 1 shows a block diagram that indicates a configuration of an information processing apparatus according to an embodiment of the present disclosure. The information processing apparatus shown in FIG. 1 includes a storage device 1, a communication device 2, and a processor 3.

The storage device 1 is a non-volatile storage device such as a flash memory or a hard disk drive, and stores sorts of data and programs.

The communication device 2 is a device capable of data communication, such as a network interface, a peripheral device interface or a modem, and performs data communication with another device, if required.

The processor 3 is a computer that includes a CPU (Central Processing Unit), a ROM (Read Only Memory), a RAM (Random Access Memory) and the like, loads a program from the ROM, the storage device 1 or the like to the RAM, and executes the program with the CPU and thereby acts as various processing units. Here, the processor 3 acts as a learning control unit 21 and a machine learning processing unit 22.

The learning control unit 21 causes the machine learning processing unit 22 to perform machine learning in accordance with hyperparameters.

The hyperparameters are not parameters in a neural network that is a target of the machine learning, but parameters in the machine learning process, such as a learning rate, a dropout ratio, a data augmentation variation range width, a batch size, and/or an epoch number.

The machine learning processing unit 22 performs machine learning of a predetermined neural network.

Here, the neural network is a deep neural network, which includes two or more hidden layers. Therefore, it is a neural network for which machine learning is deep learning. Further, a known structure and known machine learning can be used for this deep neural network.

The learning control unit 21 performs former-stage learning and latter-stage learning using the machine learning control unit 22. In the former-stage learning, the learning control unit 21 causes the machine learning processing unit 22 to advance the machine learning with a specific value set of the hyperparameters without adjusting any of the hyperparameters; and thereafter in the latter-stage learning the learning control unit 21 sets initial values of parameters as values of parameters (weight coefficients and biases) of the neural network obtained in the former-stage learning and causes the machine learning processing unit 22 to advance plural parallel processes of the machine learning with respective value sets of the hyperparameters.

Specifically, (a) in the former-stage learning, the learning control unit 21 causes the machine learning processing unit 22 to perform the machine learning with a single value set (e.g. a default fixed value set specified by a user) of the hyperparameters until a predetermined first condition is satisfied and saves a parameter value of the neural network when the predetermined first condition is satisfied; and (b) in the latter-stage learning, the learning control unit 21 sets an initial parameter value of the neural network as the saved parameter value of the neural network and changes a value set of the hyperparameters and causes the machine learning processing unit 22 to perform the machine learning with the value set until a predetermined second condition is satisfied.

Here, the first and second conditions are set on the basis of a learning error, an epoch number and/or the like.

For example, the first condition is set as that the learning error of the machine learning gets less than a predetermined first threshold value, and the second condition is set as that the learning error of the machine learning gets less than a predetermined second threshold value, where the second threshold value is set so as to be less than the first threshold value.

Here, the learning error is calculated on the basis of evaluation data (a pair of input data and output data) prepared other than training data for the machine learning. Specifically, the input data in the evaluation data is inputted to the target neural network, and the learning error is derived on the basis of a difference between the output data in the evaluation data and output data outputted from the target neural network.

In the latter-stage learning, the learning control unit 21 changes each value in the value set of the hyper parameters within a predetermined range. In addition, in the latter-stage learning, the learning control unit 21 repeatedly changes the value set of the hyperparameters in accordance with a known method such as Random Search, Grid Search, or Bayesian Optimization.

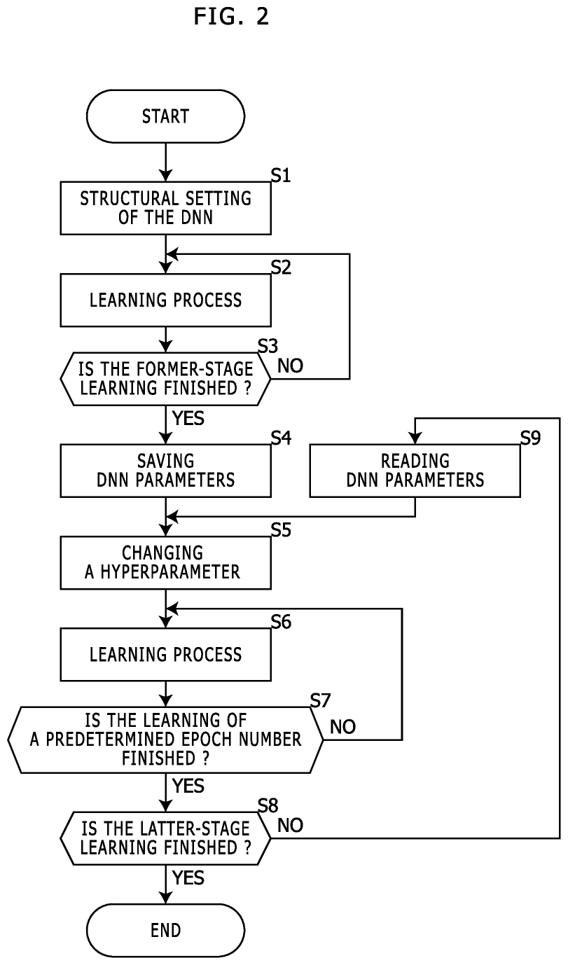

The following part explains a behavior of the aforementioned apparatus. FIG. 2 shows a flowchart that explains a behavior of the information processing apparatus shown in FIG. 1.

Firstly, the learning control unit 21 sets a structure (the number of intermediate layers, the number of neurons in each layer and the like) of a neural network that is a target of the machine learning (in Step S1). The number of neurons in the input layer and the number of neurons in the output layer are determined on the basis of input data and output data in the training data, and the other structure is set in advance, for example, by a user.

Subsequently, the learning control unit 21 causes the machine learning processing unit 22 to perform a machine learning process (the former-stage learning) for the neural network (in Step S2). In this process, the machine learning processing unit 22 performs the machine learning process for the neural network with training data that has been stored in the storage device 1 or the like.

When the machine learning processing unit 22 finishes performing the machine learning process predetermined times, the learning control unit 21 determines whether the former-stage learning should be finished or not (in Step S3). If it is determined that the former-stage learning should not be finished, then the learning control unit 21 continues the former-stage learning in Step S2. If it is determined that the former-stage learning should be finished, then the learning control unit 21 terminates the former-stage learning, and saves current values of parameters (i.e. weight coefficients and the like) of the neural network (in Step S4).

For example, in Step S3, the machine learning processing unit 22 derives a current learning error of the neural network on the basis of the evaluation data, and if the learning error is less than a predetermined threshold value, then terminates the former-stage learning.

Subsequently, the learning control unit 21 performs the latter-stage learning. Firstly, the learning control unit 21 changes a value set of the hyperparameters in accordance with a predetermined manner (i.e. Random Search, Bayesian Optimization, or the like) (in Step S5), and causes the machine learning processing unit 22 to perform the machine learning process of a predetermined epoch number with the changed hyperparameters (in Steps S6 and S7).

When the machine learning process of the predetermined epoch number is finished, then the learning control unit 21 determines whether the latter-stage learning should be terminated or not (i.e. whether the machine learning with a proper value set of the hyperparameters is finished or not) (in Step S8). If it is determined that the latter-stage learning should not be terminated, then the learning control unit 21 (saves, as a learning result, a current value set of the hyperparameters and values of the parameters of the neural network such that the both are associated with each other, if required; and thereafter) reads values of the parameters of the neural network, saved in Step S4, and sets initial parameter values as the read values (in Step S9); changes the value set of the hyperparameters (in Step S5); and subsequently performs the processes in and after Step S6.

Contrarily, if it is determined in Step S8 that the latter-stage learning should be terminated, then the learning control unit 21 saves, as a learning result, a current value set of the hyperparameters and values of the parameters (weight coefficients and the like) of the neural network such that the both are associated with each other, and terminates the machine learning.

As mentioned, in the aforementioned Embodiment 1, the learning control unit 21 performs former-stage learning and latter-stage learning. In the former-stage learning, the learning control unit 21 causes the machine learning processing unit 22 to perform the machine learning with a single value set of the hyperparameters until a predetermined first condition is satisfied and saves a parameter value of the neural network when the predetermined first condition is satisfied. Subsequently, in the latter-stage learning, the learning control unit 21 sets an initial parameter value of the neural network as the saved parameter value of the neural network and changes a value set of the hyperparameters and causes the machine learning processing unit 22 to perform the machine learning with the value set until a predetermined second condition is satisfied.

Consequently, the hyperparameters are adjusted in the latter-stage learning after the former-stage learning advances the machine learning until the middle, and therefore the adjustment of the hyperparameters is finished in a relatively short time.

### Embodiment 2

In Embodiment 2, the learning control unit 21, in aforementioned Step S1, (a) sets each value in the value set of the hyperparameters as a value within the range such that the value requires a most complicated structure (i.e. the number of intermediate layers, the number of neurons in each layer, and/or the like) of the neural network, and changes a structure of the neural network and causes the machine learning processing unit 22 to perform the machine learning until a predetermined condition is satisfied; and (b) performs the former-stage learning and the latter-stage learning of the neural network with the structure obtained at a time that this predetermined condition is satisfied. It should be noted that in this process, as well as in the aforementioned former-stage learning, a predetermined single value set is applied to the hyperparameters.

For example, the learning control unit 21 repeatedly increases the number of intermediate layers, the number of neurons in each layer and the like in the neural network from predetermined initial values, and causes to repeatedly perform the machine learning of the neural network having each structure while increasing the intermediate layers, the neurons, and the like; determines a structure obtained at a time that the learning error gets less than a predetermined threshold value, and sets the determined structure to the neural network that is a target of the machine learning; and subsequently performs the aforementioned former-stage and latter-stage learning.

For example, if a width of an image rotation range in the data augmentation is limited within a range of 0 to 15 degrees, then 15 degrees as the maximum value is the value that requires the most complicated structure of the neural network; and therefore, under a condition that the width of an image rotation range in the data augmentation is fixed to 15 degrees, the structure of the neural network as a target of the machine learning is determined in the aforementioned manner. Similarly, for example, if the dropout ratio is limited within a range of 0 to 60 percent, then 60 percent as the maximum value is the value that requires the most complicated structure of the neural network; and therefore, under a condition that the dropout ratio is fixed to 60 degrees, the structure of the neural network as a target of the machine learning is determined in the aforementioned manner.

Other parts of the configuration and behaviors of information processing apparatus in Embodiment 2 are identical or similar to those in Embodiment 1, and therefore not explained here.

As mentioned, in the aforementioned Embodiment 2, before the former-stage and latter-stage learning, a proper structure is determined of the neural network that is a target of the machine learning; and consequently, in the former-stage and latter-stage learning, the learning error decreases properly.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiments, if Bayesian Optimization is used, the termination condition of the latter-stage learning (in Step S8) may be whether the learning error has been converged (i.e. whether a difference between a current value and a previous value of the learning error gets less than a predetermined threshold value).

Further, in the aforementioned embodiments, the termination condition of the latter-stage learning (in Step S8) may be the number of changing times of the value set of the hyperparameters. In such a case, among learning results (i.e. parameter values of the neural network) with the respective value sets of the hyperparameters, the learning result having the smallest learning error is selected and determined as parameter values of the neural network that is a target of the machine learning.

Furthermore, in the aforementioned Embodiment 1, in the former-stage learning or the latter-stage learning, if the learning error does not get less than the threshold value even though the machine learning process is performed the predetermined times, then the former-stage and latter-stage learning may be performed again after canceling the machine learning process and changing the structure of the neural network (i.e. increasing the number of the intermediate layers and/or the number of the neurons in the intermediate layer).

What is claimed is:

1. An information processing apparatus, comprising:
a machine learning processing unit configured to perform machine learning of a predetermined neural network; and
a learning control unit configured to cause the machine learning processing unit to perform machine learning in accordance with hyperparameters;
wherein the learning control unit performs former-stage learning and latter-stage learning after the former-stage learning, and (a) in the former-stage learning, causes the machine learning processing unit to perform the machine learning with a single value set of the hyperparameters until a predetermined first condition is satisfied and saves a parameter value of the neural network when the predetermined first condition is satisfied, and (b) in the latter-stage learning, sets an initial parameter value of the neural network as the saved parameter value of the neural network and changes a value set of the hyperparameters and causes the machine learning processing unit to perform the machine learning with the value set until a predetermined second condition is satisfied.

2. The information processing apparatus according to claim 1, wherein the first condition is that a learning error of the machine learning is less than a predetermined first threshold value;
the second condition is that a learning error of the machine learning is less than a predetermined second threshold value; and
the second threshold value is less than the first threshold value.

3. The information processing apparatus according to claim 1, wherein the learning control unit changes each value in the value set of the hyperparameters within a predetermined range; and
the learning control unit (a) sets each value in the value set of the hyperparameters as a value within the range, the value requiring a most complicated structure of the neural network, and changes a structure of the neural network and causes the machine learning processing unit to perform the machine learning until a predetermined third condition is satisfied; and (b) performs the former-stage learning and the latter-stage learning of the neural network with the structure obtained at a time that the predetermined third condition is satisfied.
